(19) United States
(12) Patent Application Publication
(10) Pub. No.: US 2017/0357563 A1
(43) Pub. Date: Dec. 14, 2017

(54) Method, System for Automatic Monitoring, Control of Compliance of Operations of Smart-City Infrastructure in Real-Time

(71) Applicant: Wipro Limited, Bangalore (IN)

(72) Inventor: Vikas SHAH, Phoenixville, PA (US)

(73) Assignee: Wipro Limited

(21) Appl. No.: 15/178,863

(22) Filed: Jun. 10, 2016

(51) Int. Cl. G06F 11/34; G06F 11/32; G06F 17/30

(52) U.S. Cl. CPC G06F 11/3466; G06F 17/30982; G06F 17/30085; G06F 11/327

(57) ABSTRACT

The present disclosure provides method and system for automatic monitoring and control of compliance of one or more operations of smart city infrastructure in real-time. Compliance management system detects conflict initiated by compliance violation of one or more operations related to plurality of registered participants of smart city infrastructure. The compliance management system identifies policies associated with compliance of one or more operations and determines criticality of compliance of one or more operations based on one or more policies. The compliance management system determines relationship among compliance of one or more operations based on interdependencies among the operations. Further, the compliance management system generates action plan based on availability of one or more resources corresponding to compliance of one or more operations in real-time and relationship. Finally, the compliance management system monitors execution action plan to remove the conflict and achieve compliance of one or more operations based on criticality.

### TECHNICAL FIELD

The present subject matter is related in general to Smart city management, and more particularly, but not exclusively to a method and a system for automatic monitoring and control of compliance of one or more operations of a smart city infrastructure in real-time.

### BACKGROUND

Generally, the smart cities concept is based on integrating multiple systems in an intelligent manner to manage one or more interconnected operations of multiple systems effectively. Service areas of the multiple systems covered under smart cities may comprise transportation, healthcare, safety and security, education, utilities, and real estate. Digital relationship of city agencies with citizens and businesses is the backbone that enables the building of smart cities and connected communities. As an example, consider a roadside emergency situation. The immediate three tasks that have to be performed in this situation may be calling for dispatch of an emergency vehicle such as ambulance, fire truck, or police at the location of emergency, sending a notification to traffic lights management office of the emergency location to manage the traffic lights and alerting smart vehicles to clear and diversify the route for the emergency vehicle to pass. The above mentioned tasks are interconnected and have to comply with each other, which is possible only due to the digital relationships. In spite of having, the digital relationships, there are issues in making the tasks comply with each other. Based on the above mentioned scenario, some of the issues may be, deciding which among the above mentioned tasks should be performed first, since all the tasks are time sensitive. Further, complexity increases in managing the tasks when there are multiple scenarios like the above mentioned scenarios occurring simultaneously.

Managing the smart cities is not easy as there are growing challenges rising with time. One of the main issues is continuous evaluation of the adherence of compliances that belong to diversified service areas in association with digital technologies. Secondly, rationalizing and managing smart city policies based on hierarchical aspects of service areas in real-time is a difficult task. Also, ensuring that the necessary controls and procedures are in place to predominantly satisfy the compliances as well as their anomalies in various scenarios is a major issue.

Currently, smart city maturity models have been proposed and are in utilization. These maturity models focus on incorporating various service areas, interoperability, information technologies, and streamlining the communication. These models indicate the advancement of smart city development program. Further, there are tools available to define compliances and define the policies for the various service areas. Furthermore, there are models that focus on developers of the smart city and building specific protocols. But, the current models do not provide any indication of relationship of the operational compliances. Further, the current models require manual intervention and a committee to evaluate and publish the operational compliances. Also, the current models are not capable of checking the operational compliances across multiple service areas and prioritizing the operations.

### SUMMARY

One or more shortcomings of the prior art are overcome and additional advantages are provided through the present disclosure. Additional features and advantages are realized through the techniques of the present disclosure. Other embodiments and aspects of the disclosure are described in detail herein and are considered a part of the claimed disclosure.

Disclosed herein are a method and a system for automatic monitoring and control of compliance of one or more operations of a smart city infrastructure in a real-time. The compliance management system mainly works based on participants of a smart city infrastructure and the one or more operations associated with the participants. Further, the compliance management system continuously evaluates the one or more operations to ensure adherence of the compliance and for removing conflict initiated due to compliance violation. of the one or more operations automatically. The compliance management system further determines relationship among the compliance of the one or more operations dynamically based on interdependencies among the one or more operations thereby generating an action plan for removing the conflict. The automated and dynamic features of the compliance management system provide an adaptive platform that is capable of working with any service area or the participant.

Accordingly, the present disclosure provides a method for automatic monitoring and control of compliance of one or more operations of a smart city infrastructure in real-time. The method comprises steps of detecting, by a compliance management system, a conflict initiated by compliance violation of one or more operations, wherein the one or more operations are related to plurality of registered participants of a smart city infrastructure. Thereafter, the compliance management system identifies one or more policies associated with compliance of the one or more operations, from a policy database associated with the compliance management system. Further, the compliance management system determines a criticality of the compliance of the one or more operations based on the one or more policies. Furthermore, the compliance management system determines a relationship among the compliance of the one or more operations based on interdependencies among the one or more operations. Upon determining the relationship, the compliance management system generates an action plan, based on availability of one or more resources corresponding to the compliance of the one or more operations in real-time and the relationship. The availability of the one or more resources is detected when the interdependencies among the one or more operations exist. Finally, the compliance management system provides the action plan comprising a notification with the one or more operations to be performed by the corresponding plurality of registered participants to remove the conflict based on the criticality.

Further, the present disclosure comprises a compliance management system for automatic monitoring and control of compliance of one or more operations of a smart city infrastructure in real-time. The compliance management system comprises a processor and a memory communicatively coupled to the processor, wherein the memory stores the processor-executable instructions. Processor-executable instructions causes the processor to perform steps of detecting a conflict initiated by compliance violations of one or more operations, wherein the one or more operations are related to plurality of registered participants of a smart city infrastructure. Thereafter, the processor identifies one or more policies associated with compliance of the one or more operations, from a policy database associated with the compliance management system. Further, the processor determines a criticality of the compliance of the one or more operations based on the one or more policies. Furthermore, the processor determines a relationship among the compliances of the one or more operations based on interdependencies among the one or more operations. Upon determining the relationship, the processor generates an action plan, based on availability of one or more resources corresponding to the compliance of the one or more operations in real-time and the relationship. The availability of the one or more resources is detected when the interdependency among the one or more operations exist. Finally, the processor provides the action plan comprising a notification with the one or more operations to be performed by the corresponding plurality of registered participants to remove the conflict based on the criticality.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DIAGRAMS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

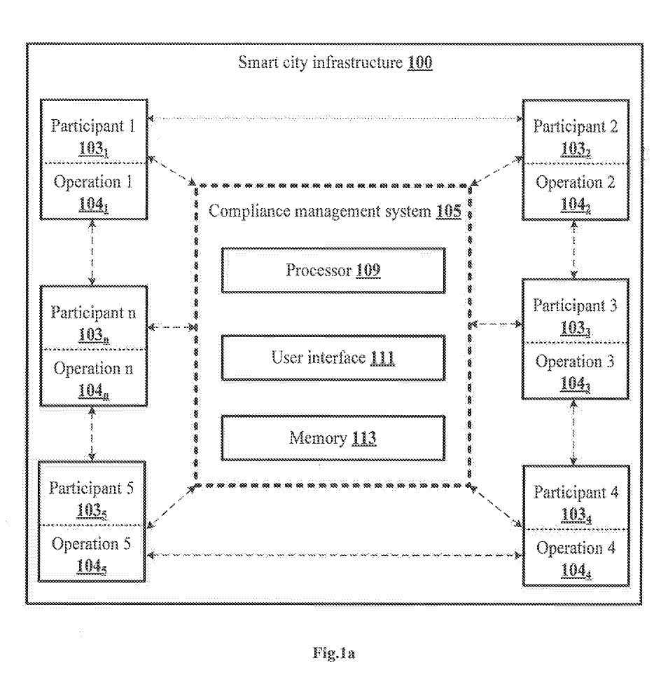

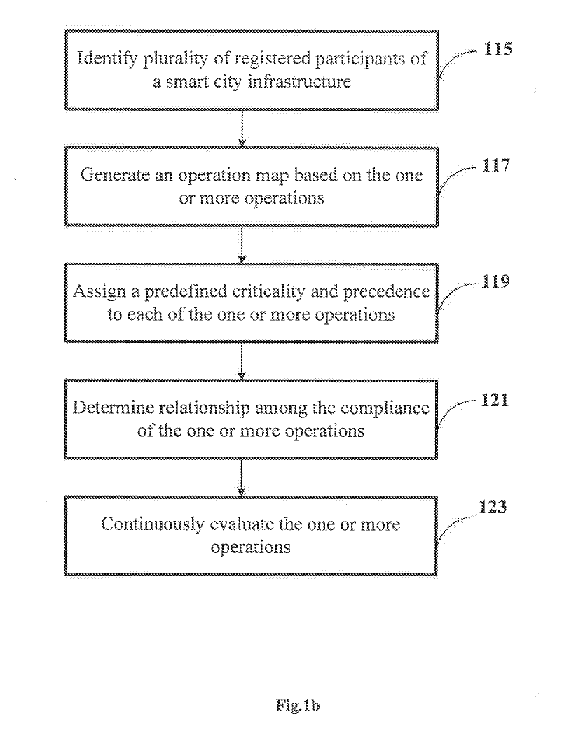

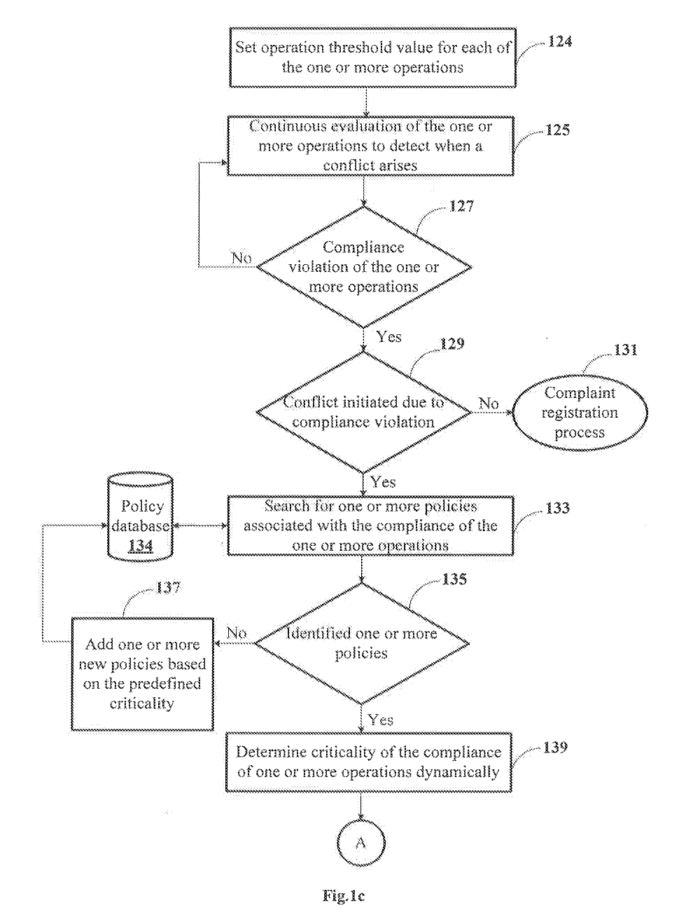

FIG. 1a shows an exemplary smart city infrastructure for automatic monitoring and control of compliance of one or more operations of a smart city infrastructure in real-time in accordance with some embodiments of the present disclosure;

FIG. 1b illustrates a flowchart to show the process of establishing a smart city infrastructure in accordance with some embodiments of the present disclosure;

FIG. 1c-FIG. 1f illustrates flowcharts to show the process of automatic monitoring and control of compliance of one or more operations of a smart city infrastructure in real-time in accordance with some embodiments of the present disclosure;

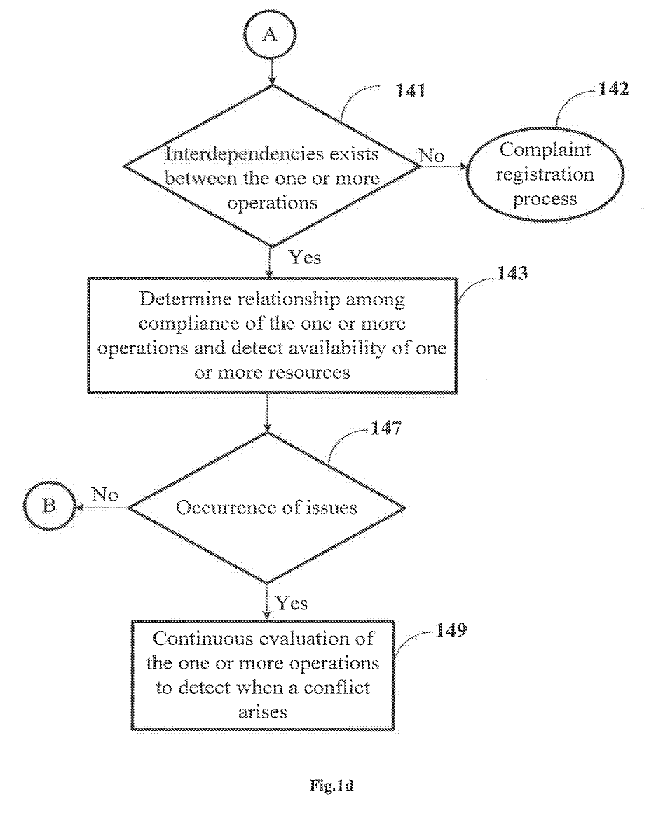

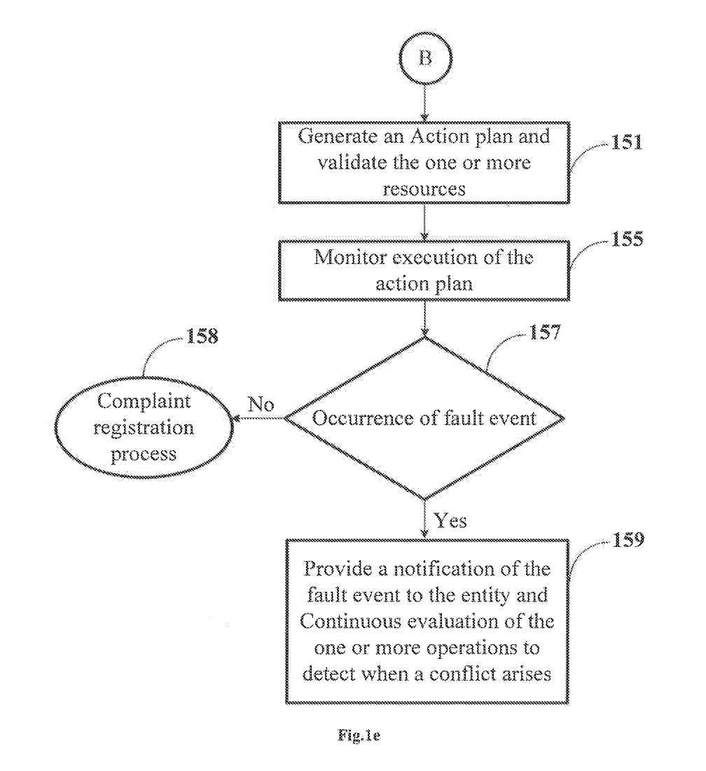

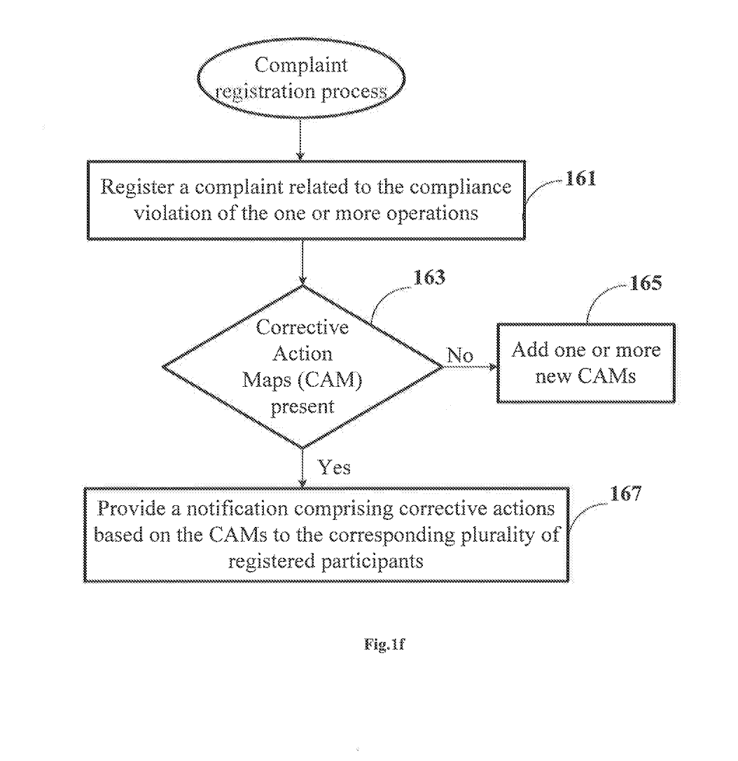

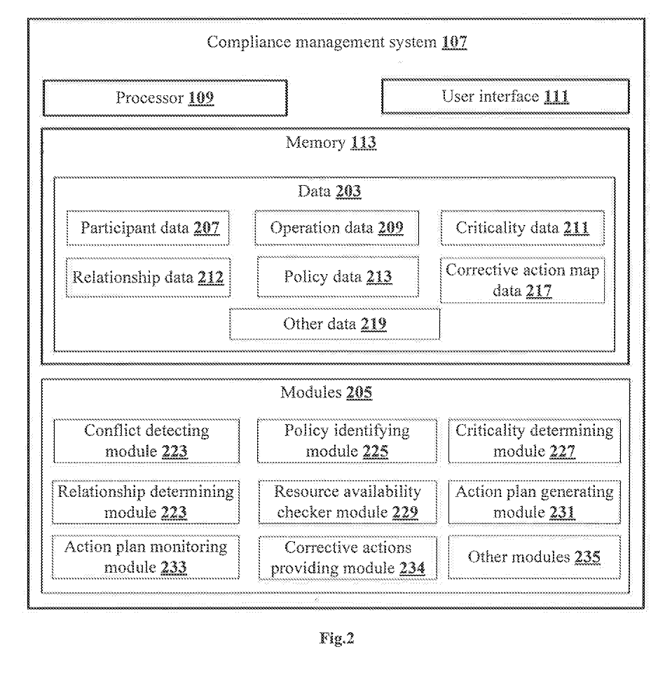

FIG. 2 shows a detailed block diagram of a compliance management system for automatic monitoring and control of compliance of one or more operations of a smart city infrastructure in real-time in accordance with some embodiments of the present disclosure;

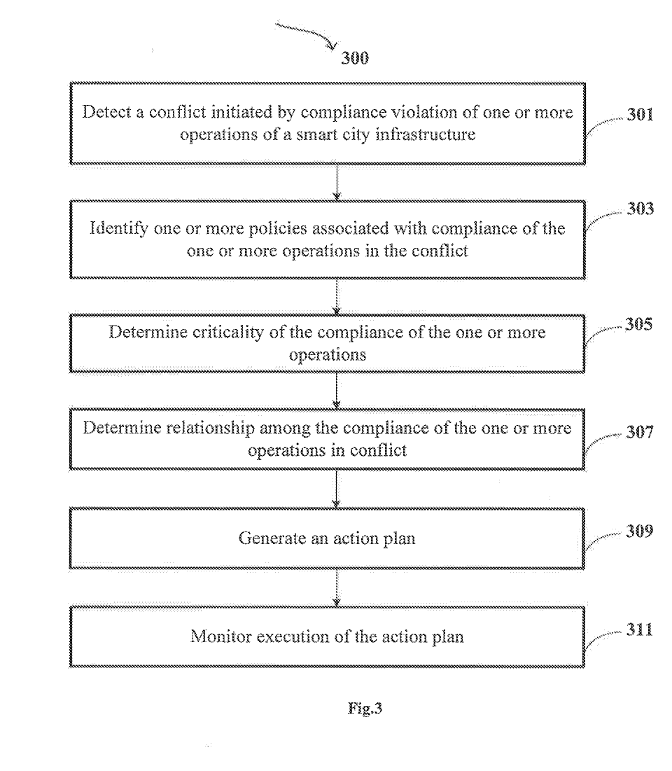

FIG. 3 illustrates a flowchart for automatic monitoring and control of compliance of one or more operations of a smart city infrastructure in real-time in accordance with some embodiments of the present disclosure; and

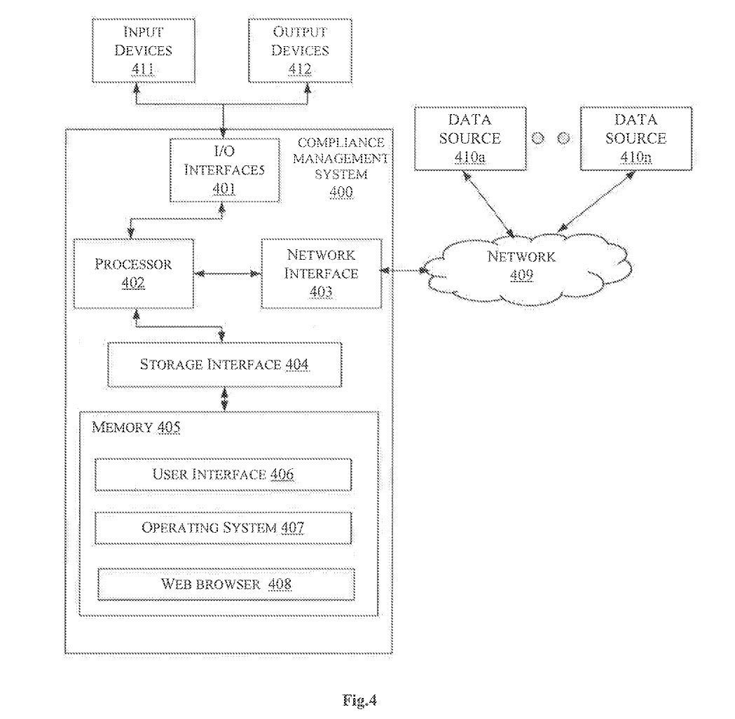

FIG. 4 is a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The present disclosure relates to a method and a system for automatic monitoring and control of compliance of one or more operations of a smart city infrastructure in real-time. The one or more operations are related to plurality of registered participants of a smart city infrastructure. As an example, the plurality of registered participants may include, but not limited to, departments like Inland Revenue department (IRD), police department etc., agencies like an advertising agency, a real estate agency etc., public sectors like military, government healthcare units etc., private sectors like private healthcare units, business, private banks, private chit fund companies etc., and contractors like a freelance architect, a freelance professor etc. In an embodiment, the compliance management system facilitates addition, deletion and update of the compliances of the one or more operations dynamically at any stage of the smart city infrastructure. Also, the compliance management system is adaptable to any service area. The system can be customized based on the plurality of registered participants of the smart city infrastructure.

The compliance management system continuously evaluates the one or more operations to detect a conflict initiated by compliance violation of one or more operations. Upon detecting the conflict, the compliance management system identifies one or more policies associated with compliance of the one or more operations, from a policy database associated with the compliance management system. The one or more policies are enforcements of the government of the smart city based on which the compliances of the one or more operations are defined. In an embodiment, the one or more new policies may be added dynamically if the one or more policies are not present in the policy database and one or more policies can be dynamically updated. Further, the compliance management system determines a criticality of the compliance of the one or more operations based on the one or more policies.

Upon determining the criticality, the compliance management system determines a relationship among the compliance of the one or more operations based on interdependencies among the one or more operations. Upon determining the relationship, the compliance management system generates an action plan. The compliance management system detects the availability of the one or more resources when the interdependencies among the one or more operations exist. Further, the action plan is generated based on availability of one or more resources corresponding to the compliance of the one or more operations in real-time and the relationship. Upon generating the action plan, the compliance management system monitors execution of the action plan to remove the conflict based on the criticality. Further the compliance management system provides a notification comprising one or more corrective actions to the corresponding plurality of registered participants and achieves compliance of the one or more operations. In an embodiment, the compliance of the one or more operations can be changed in real-time based on the scenario.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

FIG. 1a shows an exemplary architecture of a smart city infrastructure for automatic monitoring and control of compliance of one or more operations of a smart city infrastructure in real-time in accordance with some embodiments of the present disclosure.

The architecture of a smart city infrastructure 100 comprises plurality of registered participants, participant 1 103₁ to participant n 103ₙ (collectively referred to as plurality of registered participants 103), one or more operations, operation 1 104₁ to operation n 104ₙ (collectively referred to as one or more operations 104) and a compliance management system 105. In an embodiment, the smart city infrastructure 100 may comprise one or more stages. As an example, the one or more stages may include, but not limited to, initiation of the smart city infrastructure 100, evolution of the smart city infrastructure 100 and technological advancements of the smart city infrastructure 100. The plurality of registered participants 103 register with an entity associated with the compliance management system 105 to be a part of the smart city infrastructure 100. As an example, the plurality of registered participants 103 may include, but not limited to, departments like Inland Revenue department (IRD), police department etc., agencies like an advertising agency, a real estate agency etc., public sectors like military, government healthcare units etc., private sectors like private healthcare units, business, private banks, private chit fund companies etc., and contractors like a freelance architect, a freelance professor etc. As an example, the entity may be a compliance enforcement team. The one or more operations 104 comprise tasks of each of the plurality of registered participants 103. As an example, the one or more operations 104 performed by a healthcare unit may be surgeries, patient consulting, dispatch of ambulance during an emergency condition etc., the one or more operations performed by a freelance professor may be teaching, creating study materials, featuring in video tutorials etc. In an embodiment, the plurality of registered participants 103 communicates in the smart city infrastructure 100 through a communication network (not shown in the figure). As an example, the communication network may be a wired communication network or a wireless communication network. The process of establishing the smart city infrastructure 100 is illustrated in FIG. 1b. The process of establishing the smart city infrastructure 100 as illustrated in FIG. 1b is a one-time process which may be performed manually. Further, any improvements or evolution in the smart city may be dynamically updated to the smart city infrastructure 100.

Referring now to FIG. 1b, the process of establishing the smart city infrastructure is illustrated, in accordance with some embodiments of the present disclosure. At block 115, the plurality of registered participants 103 of the smart city infrastructure 100 are identified, in an embodiment, the entity identifies the plurality of registered participants 103 i.e. those who have registered with the entity to be a part of the smart city infrastructure 100. In an embodiment, the plurality of registered participants 103 may be added or updated dynamically to the smart city infrastructure 100.

At block 117, an operation map is generated based on the one or more operations 104 of each of the plurality of registered participants 103. In an embodiment, the entity recognizes the one or more operations 104 performed by each of the plurality of registered participants 103 based on corresponding roles of each of the plurality of registered participants 103 in the smart city. Upon recognizing the one or more operations 104 of each of the plurality of registered participants 103, the entity generates the operation map. The operation map illustrates connections to be established between the plurality of registered participants 103 based on the one or more operations 104 performed by each of the plurality of registered participants 103. An exemplary operation map is as shown in the below Table 1. An automatic door, a sensor, maintenance personnel and dam authority are exemplary participants in the scenario shown in Table 1.

| | | Hierarchy | | | |
|---|---|---|---|---|---|
| Participant | Operation | level | Dependency | Threshold | Criticality |
| Automatic | Open the | 2 | Sensor: Detect | Time: | Moderate |
| Door | door | | incoming object | 10 AM | |
| | | | OR | | |
| | | | Sensor: Detect | Open | |
| | | | maintenance | within 2 | |
| | | | personnel | seconds | |
| | Close the | 2 | Individual: Exit | Time: 6 PM | Moderate |
| | door | | the dam | Close | |
| | | | Maintenance | within 2 | |
| | | | Personnel: Exit | seconds | |
| | | | the dam after | | |
| | | | maintenance | | |
| | Halt the door | 3 | Sensor: Detect | Within 1 | Catastrophic |
| | | | speed of | second | |
| | | | incoming object | If speed is | |
| | | | | >20 mph | |
| Sensor | Detect | 1 | Individual: | Within 1 sec | Significant |
| | incoming | | Enter the dam | | |
| | object | | | | |
| | Detect | 1.1 | Sensor: Detect | ID: 20678 | Moderate |
| | maintenance | | incoming object | to ID: | |
| | personnel | | Maintenance | 20876 | |
| | | | Personnel: | | |
| | | | Enter to dam | | |
| | | | after hours | | |
| | Detect speed | 2 | Sensor: Detect | Within 10 | Catastrophic |
| | of incoming | | incoming object | ms of | |
| | object | | | detecting | |
| | | | | object | |
| | Notification | 4 | Automatic | Within 1 | Significant |
| | to the | | Door: Halt the | second of | |
| | participant | | door | halting of | |
| | | | | the door | |
| Maintenance | Enter to dam | 1 | | TIME: | Moderate |
| Personnel | after hours | | | Before | |
| | | | | 10 AM or | |
| | | | | TIME: | |
| | | | | After 6 PM | |
| | Provide | 3 | Automatic | Within 1 | Moderate |
| | maintenance | | | Door: Open the | hour of |
| | service | | | door | entry |
| | | | | | time + |
| | | | | | TIME: |
| | | | | | Before |
| | | | | | 10 AM or |
| | | | | | TIME: |
| | | | | | After 6 PM |
| | Exit the dam | 4 | Maintenance | TIME: | Moderate |
| | after | | Personnel: | Before | |
| | maintenance | | Provide | 10 AM or | |
| | | | maintenance | TIME: | |
| | | | service | After 6 PM | |
| | | | Automatic door: | | |
| | | | Open the door | | |
| Dam | Receive | 5 | Sensor: | Within 1 | Significant |
| Authority | compliance | | Notification to | second of | |
| | violation | | the participant | violation | |
| | notification | | | occur | |
| | Perform | 6 | Dam Authority: | Within 2 | Significant |
| | corrective | | Receive | seconds of | |
| | action of | | compliance | notification | |
| | closing the | | violation | received | |
| | door | | notification | | |
| | | | And | | |
| | | | Not (Sensor: | | |
| | | | Detect | | |
| | | | incoming | | |
| | | | object) | | |

In an embodiment, the one or more operations 104 may be added or updated dynamically to the operation map. Further, compliance is defined for each of the one or more operations 104 based on one or more policies defined for the compliance management system 105. In one embodiment, the policies correspond to government enforcements of the smart city.

At block 119, a predefined criticality and precedence is assigned to compliance of each of the one or more operations 104. In an embodiment, the entity derives a hierarchy of the compliance of the one or more operations 104 by assigning a predefined criticality to each of the compliance of each of the one or more operations 104. The predefined criticality may belong to one of one or more categories. As an example, the one or more categories may include, but not limited to, “catastrophic”, “significant”, “moderate”, “low” and “negligible”.

The hierarchy of the compliance of the one or more operations 104 indicates an order in which the one or more operations 104 have to he performed when there is a requirement. In an embodiment, the predefined criticality is assigned based on how the plurality of registered participants 103, are associated to each other in the smart city. Further, the entity assigns the precedence to each of the one or more operations 104. As an example, the precedence assigned to an operation belonging to the “catastrophic” category may be “emergency”.

At block 121, a relationship among the compliance of the one or more operations 104 is determined. In an embodiment, the entity determines the relationship among the compliance of the one or more operations 104 based on interdependencies among the one or more operations 104. As an example, consider a scenario when an accident has occurred on the road. The one or more operations 104 to be performed immediately may be requesting an ambulance service, notifying traffic lights management office and alerting vehicles on road to diversify route taken by the ambulance. Therefore, there exists a relationship among the three operations of the accident scenario wherein these operations are of three different participants of the plurality of the registered participants 103. Further, the requested ambulance service may not reach the destination on time if the traffic lights management office does not control the traffic lights to clear route for the ambulance. Therefore, there exists interdependency for proper functioning among the operations.

At block 123, compliance of the one or more operations 104 is continuously evaluated. In an embodiment, the entity adds one or more new policies dynamically and updates one or more policies dynamically, as the smart city infrastructure 100 evolves, upon continuous evaluation of the compliance of the one or more operations 104. Further upon continuous evaluation the one or more operations 104 are updated and one or more new operations 104 are added.

The compliance of the one or more operations 104 is continuously evaluated by the compliance management system 105. The compliance management system 105 comprises a processor 109, a user interface 111 and a memory 113. The processor 109 in combination with the user interface 111 and by using instructions stored in the memory 113 automatically monitors and controls compliance of the one or more operations at each of the one or more stages of the smart city infrastructure 100 in real-time as explained in the below FIGS. 1c-1f.

Referring now to FIG. 1c-FIG. 1f the process of automatic monitoring and control of compliance of one or more operations of a smart city infrastructure in real-time is illustrated, in accordance with sonic embodiments of the present disclosure.

At block 124, an operation threshold value is set. In an embodiment, the processor 109 sets the operation threshold value for each of the one or more operations 104. Further the processor 109 monitors the compliance of the one or more operations 104 based on the operation threshold value.

At block 125, the one or more operations 104 are continuously evaluated to detect occurrence of a conflict. In an embodiment, the processor 109 sets a threshold value for monitoring compliance of the one or more operations 104. The processor 109 continuously evaluates the one or more operations 104 to detect a deviation of value associated with the compliance of the one or more operations 104 from the operation threshold value.

At block 127, the processor 109 checks whether compliance violation of the one or more operations 104 was detected due to the deviation. If the compliance violation is detected, the method proceeds to block 129 via “Yes”. If the compliance violation is not detected, the method proceeds to the block 125 via “No”.

At block 129, the processor 109 checks whether a conflict is initiated due to the compliance violation. If the conflict is initiated due to the compliance violation, the method proceeds to block 133 via “Yes”. If the conflict is not initiated due to the compliance violation, the method proceeds to block 131 via “No”.

At block 131, the processor 109 performs a complaint registration process for resolving the compliance violation which is explained in detail in FIG. 1f.

At block 133, the processor 109 conducts a search in a policy database 134 of the compliance management system 105 to identify one or more policies associated with the compliance of the one or more operations 104 in the conflict from the policy database 134.

At block 135, the processor 109 checks whether the one or more policies are identified from the policy database 134. If the one or more policies are identified from the policy database 134, the method proceeds to block 139 via “Yes”. If the one or more policies are not identified from the policy database 134, the method proceeds to block 137 via “No”.

At block 137, the entity adds one or more new policies to the policy database 134 or updates one or more policies in the policy database 134 and the method proceeds to the block 133. In an embodiment, the one or more new policies are added based on the predefined criticality.

At block 139, the processor 109 determines a criticality of the compliance of the one or more operations 104 in the conflict based on the one or more policies dynamically. If the criticality at real-time is different from the predefined criticality, then the predefined criticality is replaced by the criticality determined in real-time. Further, data related to the one or more operations 104 in the conflict is retrieved from the memory 113. If the criticality at real-time is same as the predefined criticality, then no changes are performed and the data related to the one or more operations 104 in the conflict is retrieved from the memory 113. Further, upon receiving the data, the method proceeds to block 141 which is explained in detail in FIG. 1d.

Referring now to FIG. 1d, at block 141, the processor 109 checks whether, interdependencies among the one or more operations 104 in conflict exist. If the interdependencies exist, the method proceeds to block 143 via “Yes”. Further, if the interdependencies do not exist, the method proceeds to block 142 via “No”.

At block 142, the processor 109 performs the complaint registration process which is explained in detail in FIG. 1f.

At block 143, the processor 109 determines relationship among the compliance of the one or more operations 104 in the conflict. In an embodiment, the relationship is determined based on the interdependencies. In an embodiment, relationship and interdependencies may change in real-time. Further, the processor 109 detects real-time availability of one or more resources corresponding to the compliance of the one or more operations 104 in conflict based on the determined relationship. Furthermore, the processor 109 determines time required to respond based on the real-time availability of the one or more resources and the corresponding one or more operations 104 are accelerated.

At block 147, the processor 109 checks for occurrence of issues during the acceleration of the one or more operations 104 based on the availability of the one or more resources. If the issues have occurred, the method proceeds to block 149 via “Yes”. If the issues have not occurred, the method proceeds to block 151 explained in detail in the FIG. 1e.

At block 149, the processor 109 performs continuous evaluation of the one or more operations to detect when a conflict arises due to the occurrence of issues which is same as the block 125 explained in the FIG. 1c and thereby continues with flow of the process.

Referring now to FIG. 1e, at block 151, the processor 109 generates an action plan based on the real-time availability of the one or more resources and the relationship. The action plan comprises a notification comprising the one or more operations 104 to be performed by the corresponding plurality of the registered participants 103. The action plan further assigns roles and responsibilities to each of the one or more resources in real-time. The roles and responsibilities indicate tasks to be performed by the one or more resources for achieving the compliance of the one or more operations 104 in the conflict. Upon generating the action plan, the processor 109 validates capacity and capability of each of the one or more resources to ensure adherence of the compliance of the one or more operations 104 in the conflict.

At block 155, the processor 109 monitors execution of the one or more operations 104 of the action plan by the corresponding plurality of registered participants 103. Further, the one or more operations 104 of the action plan are performed based on the criticality.

At block 157, the processor 109 checks whether a fault event has occurred during the performance of the one or more operations 104. If the fault event has occurred, the method proceeds to block 159 via “Yes”. If the fault event has not occurred, the method proceeds to block 158 via “No”.

At block 158, the processor 109 confirms that the conflict initiated due to the compliance violation is removed. Further, the processor 109 performs the complaint registration process which is explained in detail in FIG. 1f.

At block 159, the processor 109 provides a notification to the corresponding plurality of registered participants 103 upon detecting the fault event. Further, the processor 109 resolves the fault event by performing continuous evaluation of the one or more operations 104 to detect when a conflict arises due to the fault event which is same as the process explained in block 125 of FIG. 1c and thereby continues with flow of the process.

Referring now to FIG. 1f, the complaint registration process is illustrated. At block 161, the processor 109 registers a complaint related to the compliance violation of the one or more operations 104 in conflict. In an embodiment, the complaint registration may be performed either manually or automatically. Further the processor 109 notifies the compliance violation of the one or more operations 104 to the corresponding plurality of registered participants 103.

At block 163, the processor 109 checks whether Corrective Action Maps (CAM) associated with the one or more operations 104 in conflict are present in the memory 113. The CAMs are used to resolve the compliance violation of the one or more operations 104. If the CAMs are present in the memory 113, the method proceeds to block 167 via “Yes”. If the CAMs are not present in the memory 113, the method proceeds to block 165 via “No”.

At block 165, the entity dynamically adds one or more new CAMs to the memory 113. Upon adding the one or more new CAMs, the method reverts to the block 163.

At block 167, the processor 109 provides a notification comprising the corrective actions based on the CAMs to the corresponding plurality of registered participants 103. By providing the notification comprising the corrective actions to be performed by the corresponding plurality of registered participants 103, the processor 109 resolves the compliance violation of the one or more operations 104 that initially caused the conflict and thereby ensures adherence of the compliance of the one or more operations 104. In an embodiment, the processor 109 dynamically updates the CAMs in the memory 113.

Scenario

As an example, consider a dam in the smart city infrastructure 100. The plurality of registered participants 103 associated in this scenario are dam authorities, an individual or group of individuals and police department. As an example, the one or more resources associated with the dam authorities are the dam, an automatic door of dam premises, one or more sensors associated with the automatic door, maintenance staff of the dam. As an example, the one or more operations 104 of the dam may be “open dam door”, “close dam door”, “status check of water flow”. As an example, the one or more operations 104 of the automatic door may be “open the automatic door”, “close the automatic door” and “halt the automatic door”. As an example, the one or more operations 104 of the one or more sensors may be “detecting an incoming object”, “detecting speed of the incoming object”, “detecting maintenance staff” and “notifying about the incoming object”. As an example, the one or more operations 104 of the maintenance staff may be “Enter dam premises to provide maintenance service”, “provide the maintenance service” and “Exit dam premises after providing the maintenance service”. As an example, the one or more operations 104 of the individual or the group of individuals may be “entering the dam premises” and “exiting the dam premises”. As an example, the one or more operations 104 of the dam authorities may be “receiving notification” and “performing corrective actions”. The compliance management system 105 continuously monitors and evaluates the one or more operations 104 to detect a conflict initiated due to compliance violation of the one or more operations 104.

Consider a scenario where one of the compliance defined for the dam is “automatic door of the dam premises should be open for the individual only from 10 AM-6 PM. After 6 PM, the automatic door should be closed and the automatic door should open only for allowing maintenance staff of the dam”. Therefore, the operation threshold value set in this scenario is “10 AM-6 PM”. The automatic door closes exactly at 6 PM according to the compliance defined. Consider time is 5:59 PM. The one or more sensors detect the time is 5:59 PM and initiates the process of dosing the automatic door. While the automatic door is moving and is half closed, the individual tries to enter into the darn premises at a very high speed. On the other hand, the compliance management system 105 is continuously monitoring the one or more operations 104.

The compliance management system 105 senses a conflict arising as the individual is approaching the automatic door of the dam premises at a very high speed. The conflict in the present scenario may be, “should the door be closed or not?”. Immediately, the compliance management system 105 identifies the one or more policies associated with the conflict. As an example, a policy may be “Causing death of an individual is a crime. The participant that caused the death of the individual shall be held liable for the crime”. Further, another policy associated with the scenario may be “Trespassers of the dam premises after the specified time shall be punished”. Therefore, the compliance management system 105 understands that the compliance demands the automatic door to be closed but, if the automatic door is closed, the one or more policies might be violated as the individual may get severely injured or may lose his life.

Upon identifying the one or more policies, the criticality is determined for the compliance of the one or more operations 104. As an example, criticality determined for saving the individual approaching the automatic door of the dam premises belongs to the “catastrophic” category as it is the most important operation to be performed in the scenario. Further, the criticality determined for closing the automatic door belongs to the “significant” category as it is the second most important operation to be performed after getting the individual out of the dam. Upon determining the criticality, the compliance management system 105 determines the relationship among the compliances of the one or more operations 104 based on the interdependencies among the one or more operations 104. In the scenario, the relationship exists among the operations “closing the door”, “saving life of the individual” and “detecting speed of the individual” since the operation “closing the door” is interdependent on the operations “detecting speed of the individual” and “saving life of the individual”. The availability of the one or more resources are detected since the interdependency exists among the one or more operations 104. As an example, the one or more resources required may be the automatic door and the one or more sensors.

Based on the one or more resources and the relationship, an action plan is generated to remove the conflict. As an example, the action plan may provide a notification comprising the operation “retract the automatic door and allow the individual inside the dam premises”. The compliance management system validates the action plan by checking if the one or more resources have the capability to perform the action plan. If the validation is successful, the action plan is executed i.e. the automatic door is retracted and the individual is allowed inside. If any fault event occurs while executing the action plan like the automatic door is not able to retract fast, the fault event is resolved by reverting to the first step i.e. the continuous evaluation and performing the complete process. During the process of removing the fault event, the compliances of the one or more operations 104 or the one or more policies may be updated dynamically. If no fault event occurs, then it indicates that the action plan is executed successfully and the conflict is removed i.e. the automatic door is retracted instead of closing, thereby saving life of the individual.

Further, the compliance management system 105 addresses the two compliance violations that have been detected. The first compliance violation is that the automatic door did not close at 6:00 PM. The second compliance violation is that the individual has entered the dam premises after 6:00 PM. The complaint related to the compliance violation of the automatic door and the individual is registered and a notification regarding the complaint is provided to the corresponding plurality of registered participants 103. As an example, the notification related to the compliance violation of the automatic door is provided to the dam authorities and the notification related to the compliance violation of the individual is provided to the police department. The compliance management system 105 provides a notification comprising corrective actions based on the CAMs to the corresponding plurality of registered participants 103 to resolve the compliance violation. The notification comprising the corrective action given to the dam authorities in this scenario may be to “close the automatic door” and the corrective action given to the police department may be to “arrest the individual for entering the dam premises after 6:00 PM”. Therefore, by closing the automatic door and by arresting the individual, the compliance violation is resolved.

In an embodiment, to follow the compliances established, if the automatic door had closed correctly at 6:00 PM, the individual approaching the automatic door of the dam premises would have lost his life. The compliance management system 105 would have violated the one or more policies and the dam authorities would have been held liable for the loss of life of the individual. The compliance management system 105 identifies the one or more policies before deciding how to resolve a conflict, to avoid the above mentioned consequences.

Therefore, the compliance management system 105 has the ability to judge the importance of the compliances based on the criticality and take correct measures at correct time without violating the one or more policies. The compliance management system 105 is a safe, secure and responsible system that manages the smart city effectively.

FIG. 2 shows a detailed block diagram of a compliance management system for automatic monitoring and control of compliance of one or more operations of a smart city infrastructure in real-time in accordance with some embodiments of the present disclosure.

In one implementation, the compliance management system 105 detects compliance violation of one or more operations 104 associated with plurality of the registered participants 103 of the smart city infrastructure 100. The compliance management system 105 stores data 203 associated with the smart city infrastructure 100. As an example, the data 203 may be stored in a memory 113 configured in the compliance management system 105. In one embodiment, data 203 comprises participant data 207, operation data 209, criticality data 211, relationship data 212, policy data 213, Corrective Action Map (CAM) data 217 and other data 219. In the illustrated FIG. 2, modules 205 are described here in detail.

In one embodiment, the data 203 may be stored in the memory 113 in the form of various data structures. Additionally, the aforementioned data 203 can be organized using data models, such as relational or hierarchical data models. The other data 219 may store data, including temporary data and temporary files, generated by modules 205 for performing the various functions of the compliance management system 105.

In an embodiment, the participant data 207 comprises a list of the plurality of registered participants 103. The plurality of registered participants 103 register with an entity associated with the compliance management system 105 to be a part of the smart city infrastructure 100. As an example, the plurality of registered participants 103 may include, but not limited to, departments like Inland Revenue department (IRD), police department etc., agencies like an advertising agency, a real estate agency etc., public sectors like military, government healthcare units etc., private sectors like private healthcare units, business, private banks, private chit fund companies etc., and contractors like a freelance architect, a freelance professor etc.

In an embodiment, the operation data 209 comprises the one or more operations 104. The one or more operations 104 comprise tasks of each of the plurality of registered participants 103. As an example, the one or more operations 104 performed by a healthcare unit may be surgeries, patient consulting, dispatch of ambulance during an emergency condition etc., the one or more operations 104 performed by a freelance professor may be teaching, creating study materials, featuring in video tutorials etc. Operation data 209 further comprises an operation map generated based on the one or more operations 104.

In an embodiment, the criticality data 211 comprises a predefined criticality associated with each of the one or more operations 104. The criticality data 211 further comprises a hierarchy of the one or more operations 104 and precedence assigned to each of the one or more operations 104 that is derived based on the predefined criticality associated with each of the one or more operations 104.

In an embodiment, the relationship data 212 comprises relationships defined among compliance of the one or more operations 104. Further, the relationship data 212 comprises interdependencies among the one or more operations 104. In an embodiment, the relationship is defined based on the interdependencies among the one or more operations 104.

In an embodiment, the policy data 213 comprises one or more policies. The one or more policies are associated with compliance of the one or more operations 104 when the one or more operations 104 are in conflict. The one or more policies are retrieved from a policy database 134 associated with the compliance management system 105. In an embodiment, the policy database 134 may be configured in the compliance management system 105 or the policy database 134 may be standalone that can be associated with the compliance management system 105.

In an embodiment, the CAM data 2117 comprises CAMs. The CAMs provide a notification comprising corrective actions for removing compliance violation of the one or more operations 104 and ensure the adherence of the compliance of the one or more operations 104. In an embodiment, the CAMs may be present in the memory 113 or the CAMs may be stored in a database associated with the compliance management system 105. The CAM data 217 also comprises one or more new CAMs that are added in real-time when requirement arises.

In an embodiment, the data stored in the memory 113 is processed by the modules 205 of the compliance management system 105. The modules 205 may be stored within the memory 113. In an example, the modules 205, communicatively coupled to a processor 109 configured in the compliance management system 105, may also be present outside the memory 113 as shown in FIG. 2 and implemented as hardware. As used herein, the term module refers to an application specific integrated circuit (ASIC), an electronic circuit, a processor (shared, dedicated, or group) and memory that execute one or more software or firmware programs, a combinational logic circuit, and/or other suitable components that provide the described functionality.

In an embodiment, the modules 205 may include, for example, a conflict detecting module 223, a policy identifying module 225, a criticality determining module 227, a relationship determining module 228, a resource availability checker module 229, an action plan generating module 231, an action plan monitoring module 233, a corrective actions providing module 234 and other modules 235. The other modules 235 may be used to perform various miscellaneous functionalities of the compliance management system 105. It will be appreciated that such aforementioned modules 205 may be represented as a single module or a combination of different modules.

In an embodiment, the conflict detecting module 223 detects a conflict. The conflict detecting module 223 continuously monitors and evaluates the one or more operations 104 to detect occurrence of a conflict based on an operation threshold value. In an embodiment, the conflict may occur due to a deviation of value associated with the compliance of the one or more operations 104 from the operation threshold value.

In an embodiment, the policy identifying module 225 identifies the one or more policies. The policy identifying module 225 searches the policy database 134 to identify one or more policies associated with the compliance of the one or more operations 104 in the conflict. If the one or more policies are not present in the policy database 134, the entity adds one or more new policies to the policy database 134. Further, the policy identifying module 225 updates the policy database 134 and identifies the one or more policies. In an embodiment, the one or more new policies are added based on the predefined criticality.

In an embodiment, the criticality determining module 227 determines a criticality of the compliance of the one or more operations 104 in the conflict dynamically. The criticality is determined based on the one or more policies identified by the policy identifying module 225. If the criticality at real-time is different from the predefined criticality, then the determining module 227 replaces the predefined criticality with the criticality. If the criticality at real-time is same as the predefined criticality, then the criticality determining module 227 performs no changes.

In an embodiment, the relationship determining module 228 determines interdependencies among the one or more operations 104 in the conflict. Based on the interdependencies, the relationship determining module 228 determines the relationship among the compliances of the one or more operations 104 in the conflict. In an embodiment, relationship and interdependencies may change in real-time.

In an embodiment, the resource availability checker module 229 detects real-time availability of one or more resources. The one or more resources correspond to the compliance of the one or more operations 104 in conflict based on the determined relationship. The resource availability checker module 229 further determines time required to respond based on the real-time availability of the one or more resources. Upon determining the time require to respond, the resource availability checker module 229 accelerates the corresponding one or more operations 104 in conflict. Further, the resource availability checker module 229 accelerates the one or more operations 104 based on the availability of the one or more resources. If the issues have occurred, the resource availability checker module 229 forwards the issue to the conflict detecting module 223 and resolves the issue before proceeding.

In an embodiment, the action plan generating module 231 generates an action plan based on the real-time availability of the one or more resources and the relationship. The action plan comprises a notification with the one or more operations 104 to be performed by the corresponding plurality of registered participants 103 to remove the conflict. The action plan generating module 231 first assigns roles and responsibilities to each of the one or more resources in real-time to generate the action plan. The roles and responsibilities indicate tasks to be performed by the one or more resources for achieving the compliance of the one or more operations 104 in the conflict. Upon generating the action plan, the action plan generating module 231 validates capacity and capability of each of the one or more resources to ensure adherence of the compliance of the one or more operations 104 in the conflict.

In an embodiment, the action plan monitoring module 233 monitors execution of the one or more operations 104 of the action plan by the corresponding plurality of registered participants 103, based on the criticality. The action plan monitoring module 233 further checks whether a fault event has occurred during the performance of the one or more operations of the action plan. If the fault event has occurred, the action plan monitoring module 233 provides a notification to the entity upon detecting the fault event. Further, the processor 109 resolves the fault event by forwarding the fault event to the conflict detecting module 223. If the fault event has not occurred or upon resolving the fault event, the action plan monitoring module 233 confines that the conflict initiated due to the compliance violation is removed.

In an embodiment, upon removing the conflict, the corrective actions providing module 234 registers a complaint related to the compliance violation of the one or more operations 104 in conflict. In an embodiment, the complaint registration may be performed either manually or automatically. Further the corrective actions providing module 234 notifies the compliance violation of the one or more operations 104 to the corresponding plurality of the registered participants 103. Upon notifying the compliance violation of the one or more operations 104, the corrective actions providing module 234 checks whether CAMs are present in the memory 113. If the CAMs are present in the memory 113, the corrective actions providing module 234 provides a notification comprising the corrective actions based on the CAMs to the corresponding plurality of registered participants 103 and resolves the compliance violation of the one or more operations 104 that initially caused the conflict. Therefore, the corrective actions providing module 234 ensures adherence of the compliance of the one or more operations 104. In an embodiment, if the CAMs are not present in the memory 113, the entity dynamically adds one or more new CAMs to the memory 113 and provides the corresponding corrective actions to the corresponding plurality of registered participants 103.

FIG. 3 illustrates a flowchart for automatic monitoring and control of compliance of one or more operations of a smart city infrastructure in real-time in accordance with some embodiments of the present disclosure.

As illustrated in FIG. 3, the method 300 comprises one or more blocks illustrating a method. for automatic monitoring and control of compliance of one or more operations 104 of a smart city infrastructure 100 in real-time. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 301, a conflict initiated by compliance violation of the one or more operations 104 is detected. In an embodiment, the processor 109 continuously monitors and evaluates the one or more operations 104 to detect occurrence of a conflict based on an operation threshold value. The processor 109 detects a conflict when a deviation of value associated with the compliance of the one or more operations 104 from the operation threshold value occurs.

At block 303, one or more policies associated with compliance of the one or more operations 104 in the conflict are identified. In an embodiment, the processor 109 identifies the one or more policies by searching a policy database 134 associated with the compliance management system 105. If the one or more policies are not present in the policy database 134, an entity adds one or more new policies, based on a predefined criticality, to the policy database 134. As an example, the entity may be a compliance enforcement team associated with the compliance management system 105. Further, the identification module 225 updates the policy database 134 and then identifies the one or more policies.

At block 305, criticality of the compliance of the one or more operations 104 in the conflict is determined. In an embodiment, the processor 109 determines the criticality dynamically based on the one or more policies. If the criticality at real-time is different from the predefined criticality, then the processor 109 replaces the predefined criticality with the criticality. If the criticality at real-time is same as the predefined criticality, then the processor 109 performs no changes.

At block 307, relationship among the compliance of the one or more operations 104 in the conflict is determined. In an embodiment, the processor 109 first determines interdependencies among the one or more operations 104 in the conflict. Based on the interdependencies, the processor 109 determines the relationship. Further, the processor 109 detects real-time availability of one or more resources if the interdependencies exist. Upon determining the real-time availability of the one or more resources, the processor 109 further determines time required to respond based on the real-time availability of the one or more resources and accelerates the corresponding one or more operations 104 in conflict.

At block 309, an action plan is generated. In an embodiment, the processor 109 generates the action plan based on the real-time availability of the one or more resources and the relationship. The action plan comprises a notification with the one or more operations 104 to be performed by the corresponding plurality of registered participants 103 to remove the conflict. The processor 109 first assigns roles and responsibilities to each of the one or more resources in real-time to generate the action plan. The roles and responsibilities indicate tasks to be performed by the one or more resources for achieving the compliance of the one or more operations 104 in the conflict. Upon generating the action plan, the processor 209 validates capacity and capability of each of the one or more resources to ensure adherence of the compliance of the one or more operations 104 in the conflict.

At block 311, the action plan is executed. In an embodiment, upon validation of the capacity and capability of each of the one or more resources, the processor 109 monitors execution of the one or more operations 104 of the action plan based on the criticality. The processor 109 further checks whether a fault event has occurred during the performance of the one or more operations of the action plan. If the fault event has occurred, the processor 109 provides a notification to the entity upon detecting the fault event and resolves the fault event. If the fault event has not occurred or upon resolving the fault event, the processor 109 confirms that the conflict initiated due to the compliance violation is removed. Upon removing the conflict, the processor 109 registers a complaint related to the compliance violation of the one or more operations 104 in conflict. In an embodiment, the complaint registration may be performed either manually or automatically. Further the processor 109 notifies the compliance violation of the one or more operations 104 to the corresponding plurality of registered participants 103. Upon notifying the compliance violation of the one or more operations 104, the processor 109 checks whether CAMs are present in the memory 113. If the CAMs are present in the memory 113, the processor 109 provides a notification comprising the corrective actions based on the CAMs to the corresponding plurality of registered participants 103 and resolves the compliance violation of the one or more operations 104 that initially caused the conflict. Therefore, the processor 109 ensures adherence of the compliance of the one or more operations 104. In an embodiment, if the CAMs are not present in the memory 113, the entity dynamically adds one or more new CAMs to the memory 113 and provides the corresponding corrective actions to the corresponding plurality of registered participants 103.

FIG. 4 is a block diagram of an exemplary computer system for implementing embodiments consistent with the present disclosure.

In an embodiment, the compliance management system 400 is used for automatic monitoring and control of compliance of one or more operations of a smart city infrastructure in real-time. The compliance management system 400 may comprise a central processing unit (“CPU” or “processor”) 402. The processor 402 may comprise at least one data processor for executing program components for executing user- or system-generated business processes. A user may include a person, a person using a device such as such as those included in this invention, or such a device itself. The processor 402 may include specialized processing units such as integrated system (bus) controllers, memory management control units, floating point units, graphics processing units, digital signal processing units, etc.

The processor 402 may be disposed in communication with one or more input/output (I/O) devices (411 and 412) via I/O interface 401. The I/O interface 401 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n /b/g/n/x, Bluetooth, cellular (e.g., Code-Division Multiple Access (CDMA), High-Speed Packet Access (HSPA+), Global System For Mobile Communications (GSM), Long-Term Evolution (LTE), WiMax, or the like), etc.

Using the I/O interface 401, the compliance management system 400 may communicate with one or more I/O devices (411 and 412).

In some embodiments, the processor 402 may be disposed in communication with a communication network 409 via a network interface 403. The network interface 403 may communicate with the communication network 409. The network interface 403 may employ connection protocols including, without limitation, direct connect, Ethernet (e.g., twisted pair 10/100/1000 Base T), Transmission Control Protocol/intranet Protocol (TCP/IP), token ring, IEEE 802.11 a/big/nix, etc. Using the network interface 403 and the communication network 409, the compliance management system 400 may communicate with one or more data sources 410 (a, . . . , n). The communication network 409 can be implemented as one of the different types of networks, such as intranet or Local Area Network (LAN) and such within the organization. The communication network 409 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the communication network 409 may include a variety of network devices, including routers, bridges, servers, computing devices, storage devices, etc. The one or more data sources 410 (a, . . . , n) may be used to provide information, related to the plurality of registered participants, to the compliance management system 400.

In some embodiments, the processor 402 may be disposed in communication with a memory 405 (e.g., RAM, ROM, etc. not shown in FIG. 4) via a storage interface 404. The storage interface 404 may connect to memory 405 including, without limitation, memory drives, removable disc drives, etc., employing connection protocols such as Serial Advanced Technology Attachment (SATA), integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, user interface application 406, an operating system 407, web server 408 etc. In some embodiments, compliance management system 400 may store user/application data 406, such as the data, variables, records, etc, as described in this invention. Such databases may be implemented as fault-tolerant, relational, scalable, secure databases such as Oracle or Sybase.

The operating system 407 may facilitate resource management and operation of the compliance management system 400. Examples of operating systems include, without limitation, Apple Macintosh OS X, UNIX, Unix-like system distributions (e.g., Berkeley Software Distribution (BSD), FreeBSD, NetBSD, OpenBSD, etc,), Linux distributions (e.g., Red Hat, Ubuntu, Kubuntu, etc.), International Business Machines (IBM) OS/2, Microsoft Windows (XP, Vista/7/8, etc.), Apple iOS, Google Android, Blackberry Operating System (OS), or the like. User interface 406 may facilitate display, execution, interaction, manipulation, or operation of program components through textual or graphical facilities. For example, user interfaces may provide computer interaction interface elements on a display system operatively connected to the compliance management system 400, such as cursors, icons, check boxes, menus, scrollers, windows, widgets, etc. Graphical User Interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the compliance management system 400 may implement a web browser 408 stored program component. The web browser may be a hypertext viewing application, such as Microsoft Internet Explorer, Google Chrome, Mozilla Firefox, Apple Safari, etc. Secure web browsing may be provided using Secure Hypertext Transport Protocol (HTTPS) secure sockets layer (SSL), Transport Layer Security (TLS), etc. Web browsers may utilize facilities such as AJAX, DHTML, Adobe Flash, JavaScript, Java, Application Programming Interfaces (APIs), etc. In some embodiments, the compliance management system 400 may implement a mail server stored program component. The mail server may be an Internet mail server such as Microsoft Exchange, or the like. The mail server may utilize facilities such as Active Server Pages (ASP), ActiveX, American National Standards Institute (ANSI) C++/C#, Microsoft .NET, CGI scripts, Java, JavaScript, PERL, PHP, Python, WebObjects, etc. The mail server may utilize communication protocols such as Internet Message Access Protocol (MAP), Messaging Application Programming Interface (MAPI), Microsoft Exchange, Post Office Protocol (POP), Simple Mail Transfer Protocol (SMTP), or the like. In some embodiments, the compliance management system 400 may implement a mail client stored program component. The mail client may be a mail viewing application, such as Apple Mail, Microsoft Entourage, Microsoft Outlook, Mozilla Thunderbird, etc.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, non-volatile memory, hard drives, Compact Disc (CD) ROMs, Digital Video Disc (DVDs), flash drives, disks, and any other known physical storage media.

Advantages of the embodiment of the present disclosure are illustrated herein.

In an embodiment, the present disclosure provides a method and a system for automatic monitoring and control of compliance of one or more operations of a smart city infrastructure in real-time.

The present disclosure defines new compliances for the one or more operations in a city as the smart city infrastructure evolves.

The present disclosure facilitates addition, deletion and update of the compliances of the one or more operations dynamically at any stage of the smart city infrastructure.

The present disclosure provides a compliance management system which is adaptable to any service area or participants. Also, the system can be customized based on the participants of the smart city infrastructure.

The present disclosure provides a feature wherein the criticality and the precedence associated with the compliance of the one or more operations can be changed in real-time based on the scenario.

The present disclosure provides a feature wherein action plan and the procedure to proceed with the action plan for removing conflict among the one or more operations is generated based on availability of the one or more resources.

The present disclosure provides a feature wherein Corrective Action Maps (CAM) are used for removing compliance violation of the one or more operations. The CAMs accommodate any extent of diversification in the form of corrective actions to resolve the compliance violation.

The present disclosure provides a feature wherein a “single view” of the compliance of the one or more operations at a very granular level can be obtained dynamically.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The specification has described a method and a device for automatic monitoring and control of compliance of one or more operations of a smart city infrastructure in real-time. The illustrated steps are set out to explain the exemplary embodiments shown, and it should be anticipated that on-going technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to he equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

### REFERRAL NUMERALS

| Reference | |
|---|---|
| Number | Description |
| 100 | Smart city infrastructure |
| 103 | Plurality of registered participants |
| 104 | One or more operations |
| 105 | Compliance management system |
| 109 | Processor |
| 111 | User interface |
| 113 | Memory |
| 134 | Policy database |
| 203 | Data |
| 205 | Modules |
| 207 | Participant data |
| 209 | Operation data |
| 211 | Criticality data |
| 212 | Relationship data |
| 213 | Policy data |
| 217 | Corrective Action Maps (CAM) data |
| 219 | Other data |
| 223 | Conflict detecting module |
| 225 | Policy identifying module |
| 227 | Criticality determining module |
| 228 | Relationship determining module |
| 229 | Resource availability checker module |
| 231 | Action plan generating module |
| 233 | Action plan monitoring module |
| 234 | Corrective actions providing module |
| 235 | Other modules |

We claim:

1. A method for automatic monitoring and control of compliance of one or more operations of a smart city infrastructure in real-time, the method comprising steps of:
detecting, by a compliance management system, a conflict initiated by compliance violation of one or more operations, wherein the one or more operations are related to plurality of registered participants of a smart city infrastructure;
identifying, by the compliance management system, one or more policies associated with compliance of the one or more operations, from a policy database associated with the compliance management system;
determining, by the compliance management system, a criticality of the compliance of the one or more operations based on the one or more policies;
determining, by the compliance management system, a relationship among the compliance of the one or more operations based on interdependencies among the one or more operations;
generating, by the compliance management system, an action plan, based on availability of one or more resources corresponding to the compliance of the one or more operations in real-time and the relationship, wherein the availability of the one or more resources is detected when the interdependencies among the one or more operations exist; and
providing, by the compliance management system, the action plan comprising a notification with the one or more operations to be performed by the corresponding plurality of registered participants to remove the conflict based on the criticality.

2. The method as claimed in claim 1 comprises creating an operation map, based on the one or more operations performed by each of the plurality of registered participants, for establishing a connection between the plurality of registered participants.

3. The method as claimed in claim 1, wherein detecting the conflict comprises:
setting, by the compliance management system, an operation threshold value for each of the one or more operations for monitoring compliance of the one or more operations; and
detecting, by the compliance management system, a deviation of value associated with the compliance of the one or more operations from the operation threshold value thereby detecting the conflict.

4. The method as claimed in claim 1, wherein one or more new policies are dynamically added to the policy database when the one or more policies are unavailable in the policy database.

5. The method as claimed in claim 1, wherein providing the action plan further comprises:
monitoring, by the compliance management system, execution of the one or more operations of the action plan by the corresponding plurality of registered participants;
detecting, by the compliance management system, occurrence of a fault event during the performance of the one or more operations;
providing, by the compliance management system, a notification to an entity associated with the compliance management system upon detecting the fault event; and
resolving, by the compliance management system, the fault event by performing steps as claimed in claim 1.

6. The method as claimed in claim 1 further comprises:
registering, by the compliance management system, at least one of a manual and an automated complaint corresponding to the compliance violation of the one or more operations and notifying the compliance violation of the one or more operations to the corresponding plurality of registered participants; and
providing, by the compliance management system, a notification comprising corrective actions based on Corrective Action Maps (CAM) stored in a memory of the compliance management system to the corresponding plurality of registered participants, to resolve the compliance violation of the one or more operations.

7. The method as claimed in claim 6, wherein one or more new CAMs are dynamically added to the memory when the CAMs are unavailable in the memory.

8. A compliance management system for automatic monitoring and control of compliance of one or more operations of a smart city infrastructure in real-time, the compliance management system comprising:
a processor; and
a memory communicatively coupled to the processor, wherein the memory stores the processor-executable instructions, which, on execution, causes the processor to perform steps of:
detecting a conflict initiated by compliance violation of one or more operations, wherein the one or more operations are related to plurality of registered participants of a smart city infrastructure;
identifying one or more policies associated with compliance of the one or more operations, from a policy database associated with the compliance management system;
determining a criticality of the compliance of the one or more operations based on the one or more policies;
determining a relationship among the compliances of the one or more operations based on interdependencies among the one or more operations;
generating an action plan, based on availability of one or more resources corresponding to the compliance of the one or more operations in real-time and the relationship, wherein the availability of the one or more resources is detected when the interdependency among the one or more operations exist; and
providing the action plan comprising a notification with the one or more operations to be performed by the corresponding plurality of registered participants to remove the conflict based on the criticality.

9. The compliance management system as claimed in claim 8, wherein the processor is configured to create an operation map, based on the one or more operations performed by each of the plurality of registered participants, for establishing a connection between the plurality of registered participants.

10. The compliance management system as claimed in claim 8, wherein the processor is configured to detect the conflict by:
setting an operation threshold value for each of the one or more operations for monitoring compliance of the one or more operations; and
detecting a deviation of value associated with the compliance of the one or more operations from the operation threshold value thereby detecting the conflicts.

11. The compliance management system as claimed in claim 9, wherein one or more new policies are dynamically added to the policy database when the one or more policies are unavailable in the policy database.

12. The compliance management system as claimed in claim 8, wherein upon providing the action plan, the processor is further configured to:
monitor execution of the one or more operations of the action plan by the corresponding plurality of registered participants;
detect occurrence of a fault event during the performance of the one or more operations;
provide a notification to an entity associated with the compliance management system upon detecting the fault event; and
resolve the fault event by performing steps as claimed in 8.

13. The compliance management system as claimed in claim 8, wherein the processor is further configured to:
register at least one of a manual and an automatic complaint corresponding to the compliance violation of the one or more operations and notifying the compliance violation of the one or more operations to the corresponding plurality of registered participants; and
provide a notification comprising corrective actions based on Corrective Action Maps (CAM), stored in a memory of the compliance management system to the corresponding plurality of registered participants, to resolve the compliance violation of the one or more operations.

14. The compliance management system as claimed in claim 14, wherein one or more new CAMs are dynamically added to the memory when the CAMs are unavailable in the memory.
